(19) United States
(12) Patent Application Publication
(10) Pub. No.: US 2010/0285440 A1
(43) Pub. Date: Nov. 11, 2010

(54) System and Method to Stimulate Human Genius

(76) Inventors: Setu Parikh, Mumbai (IN); Robin Fernandes, Mumbai (IN); Glenn Fernandes, Mumbai (IN); David Charmaine, Colaba (IN); David Aashish, Colaba (IN); Maria Fernandes, Mumbai (IN); Apoorva Agwan, Thane (IN); Pavithra Murali, Mumbai (IN); Sarita Parikh, Mumbai (IN); Surabhi Dhar, Mumbai (IN); Nancy D'Souza, Goa (IN); Lanalisa Sequeira, Borivli (West) (IN); Leonara Braganza, Mumbai (IN); Lydia Desai, Mumbai (IN)

Correspondence Address: PATENT LAW & VENTURE GROUP, 2424 S.E. BRISTOL, SUITE 300, NEWPORT BEACH, CA, 92660, US

(21) Appl. No.: 12/810,913

(22) PCT Filed: Dec. 24, 2008
(86) PCT No.: PCT/IN2008/000859

§ 371 Date: Jun. 28, 2010

(30) Foreign Application Priority Data
Dec. 27, 2007 (IN) 2574/MUM/2007

(51) Int. Cl. G09B 7/00

(52) U.S. Cl. 434/323

(57) ABSTRACT

An interactive education system for stimulating higher cognitive processes of at least one user includes an interactive interface for communicating with at least one user, a feedback component includes an assessment module and a biofeedback module, a host processor includes a multimedia module. The multimedia module includes at least one teaching module and a storage module. The storage module performs at least one modification in the at least one teaching module of the multimedia module in response to data received from the assessment module and/or the biofeedback module and a communication network for coupling the feedback component to the host processor.

### FIELD OF INVENTION

Embodiments of the present invention relate to a system for stimulating human genius, and more particularly, to a system and a method for stimulating higher cognitive processes of at least one user.

### BACKGROUND OF INVENTION

Throughout history, there have been a few rare individuals who have astounded the world with their visionary, genius, super-normal capacities—such as Einstein, Tesla, Mozart, Jesus, Buddha, Socrates, and Leonardo da Vinci. They seem to possess powers that normal people don't, and talk a language that the world does not understand. This initially led the Church to brand many of them as evil and heretics, and now the world puts them on a pedestal and treats them as “geniuses”—some rare chances of nature, who are not like the rest of us.

However in recent scenario, medical sciences have researched and found out that traits of visionary genius, such as creativity, focus, enthusiasm, intuition, vision, insight altruism, and awe, are not abstract concepts or chances of nature but are in fact higher cognitive processes, located in a specific area of the brain called the “Prefrontal Cortex.” Thus it may be inferred that every person has the natural capacity of being a visionary genius.

However, in majority of people, lower cognitive processes are more dominant, such as fear, aggression, competition, emotional upheavals, materialism and addictions (amygdala and limbic system). At the most, some people function through logic (neocortex), but it still immensely inferior to the creative, spontaneous, intuitive insight of geniuses. Consequently in majority of the people the Prefrontal cortex is fully diverted into calming down these lower cognitive impulses, and is thus not capable of functioning at its proper, higher capacities.

In Psychology, this is explained through the “Hierarchy of Needs” theory by Abraham Maslow. According to this theory, man is motivated by several levels of desires. After his lower elementary desires for safety, security, emotional bonding, and esteem are satisfied, man naturally moves towards the higher desires of “Self-actualization” i.e. realizing your potential, and excelling in one or more fields, like Einstein (physics), Mozart (music), or Leonardo da Vinci who was a painter, sculptor, engineer, astronomer, anatomist, biologist, geologist, physicist, architect, philosopher, actor, singer, musician and humanist—all in one. However, Maslow later realized that even beyond this, there is a state of “Transcendence.” It is a spiritual state of unconditional love, visionary intuition, altruism, and a feeling of oneness, embodied in people like Jesus and Buddha, which are as a matter fact the exact traits of the Prefrontal cortex, possessed by each one of us.

The state of transcendence has been known to religion and spirituality as “enlightenment”—a state where a person realizes his unlimited and infinite state. For example, brain scans of Buddhist monks in a state of deep blissful meditation, confirmed that they were utilizing their prefrontal cortex, while their lower cognitive processes were in a silent state.

We human beings learn largely through the process of “mirroring”. The process of mirroring refers to particular mirror neurons residing in our brains that imitate and imbibe not just the physical state, but also the emotional and mental state of others around us. All through our lives we rarely see anyone living and working at a state of high creativity, focus, enthusiasm, vision, intuition, insight, altruism and awe. Subsequently, we as individuals cannot learn to access these higher cognitive capacities ourselves.

In recent years, it has been observed in any field, a live mentor is valued much more than the best of courses and programs run by various institutions across the globe. The live mentor is valued not so much for his knowledge but for his experience, insight and understanding, which may be directly imbibed by the individuals. It is been rightly quoted that “We love most those who can help us be the best person we can be.”

Ancient cultures realized this. Consequently, education and religion were part of the same process. Young children were sent to temples, gurus and spiritual masters, not just for academic studies, but to directly imbibe their higher spiritual state. Once the lower cognitive processes are calmed down, learning any topic is naturally fast, easy, enjoyable and natural. That's why India seer Swami Vivekananda has stated that “Education is the manifestation of the perfection already present in man”. Similarly in the West, the great philosopher Plato has stated (in his dialogue Meno), that the soul already knows everything and the role of the teacher is simply to draw out this inherent knowledge.

However with the advent of the industrial revolution, education has been divorced from spirituality. In today's scenario, under the “factory system” of education, the focus is on the content itself and not on the user. Learning has been mechanical and fragmented, based entirely on the lower cognitive processes of fear, rote-learning and repetition. Gradually, over the generations the ability to access the higher capacities of creativity, insight, intuition, and the ability to practically use knowledge has been lost, until today, man doesn't have the slightest inkling of his true potential.

Even though education systems today are trying to improve and be more user-oriented, none of them even realize man's unlimited capacities, and consequently none are geared to produce geniuses. Similarly religion, which was intended to facilitate people in attaining enlightenment, has been unable to do so, especially on a global scale. Firstly, there is no single universal religion that may be applied worldwide. Majority of them are involved in trying to prove each other wrong, rather than incorporating the best of each other. This has led to several people losing faith in religion altogether. Secondly, most religions are based on rituals, beliefs, practices that need to be done on a sustained basis, which are tedious and unappealing, especially to children. Thirdly, religion is subjective and irrational. What works for one, may not work for another. There is no scientific, measurable, repeatable system to help each person attain enlightenment.

Even cutting-edge scientific fields, that are beginning to realize man's true potential, have been unable to develop means by which people may access it. Neurology knows that man may be a genius (amazing powers of the prefrontal cortex), Genetics knows that even genes may be changed (epigenetics, genetic engineering, wave genetics), Medical science knows that you may heal yourself (countless inexplicable medical miracles), Physiologists know that you may change even your basic physiological processes at will (monks who stop breathing, eating, regulate body temperature). However, this has been discovered by documenting cases of individuals who have tapped into their higher cognitive powers. Scientists across globe themselves have never experienced these phenomena's, and have no idea how they work, and subsequently have no way to create systems to help humanity access these abilities.

Currently, there are numerous inventions that use biofeedback to bring about online changes in Multimedia modules. But these are mainly in the fields of gaming and healthcare, for the extremely limited purpose of increasing enjoyment and excitement, monitoring illnesses, or improving human-machine interface. None of them can even conceive of the possibility of stimulating human genius, and evolving humanity to its true cognitive potential on a global scale, and hence are in no way designed to do so.

U.S. Pat. No. 6,026,322 issued on 15 Feb. 2000 to Korenman et al. titled “Biofeedback apparatus for use in therapy” describes apparatus and program to train the user to control his or her psycho-physiological state, which is controlled by signals representative of a psycho-physiological parameter of the user, e.g. galvanic skin resistance. The sensed psycho-physiological parameters of the patient are used to alter a display which the patient watches, which could include a visual or pictorial representation of the physiological condition being treated, which changes in appearance, corresponding to the physiological change desired in the patient. However this invention is designed for treating patients with physiological conditions, like irritable bowel syndrome, and not for stimulating human genius.

U.S. Pat. No. 7,331,870 issued on 19 Feb. 2008, to Smith et al, titled “Multiplayer biofeedback interactive gaming environment” describes a system in which Biometric information of a player is used to execute multimedia events in a multiplayer gaming environment, to train users to regulate their physiological conditions. E.g. reduction in stress level causes a hot air balloon to rise, or achieving a particular heart rate causes a game door to open. However, even here the purpose is to help the user control one or more physiological parameters—not to make him a genius. Further, the user has to consciously change his physiological parameters, it does not happen automatically. Hence it cannot be applied to education, where the user has to focus on the topic at hand, and not on his physiology.

U.S. Pat. No. 6,450,820 issued on 17 Sep. 2002, to Palsson et al. titled “Method and apparatus for encouraging physiological self-regulation through modulation of an operator's control input to a video game or training simulator” provides a biofeedback system that monitors the player's physiological state to cause a game controller to change the response characteristics. However this system is not designed to enhance the cognitive state of the user, but only to enhance the playing of the game. Moreover, an education system may not include any physical controls, whose characteristics may be changed, in response to the physiological state.

U.S. Pat. No. 6,067,468 issued on 23 May 2000 to Korenman et al. titled “Apparatus for monitoring a person's psycho-physiological condition” discloses the running of a program, designed to train the user to control one or more aspects of his or her psycho physiological state, controlled by signals representative of a psycho-physiological parameter of the user, such as galvanic skin resistance. However, this is a general purpose apparatus that can be adapted to gaming or education, not specifically designed to stimulate higher cognitive functioning and genius. The focus is on monitoring the psycho-physiological state of the user, and there is no specific means for assessing the performance or understanding of a user, which may be essential in an education system. Further, it does not disclose any means for use in a group situation, such as a classroom.

Furthermore, most are designed only for individual users, or for a network of individual users, or two or more users playing competitively who are being judged on limited parameters for the purpose of the game. None are designed to cater to a group learning situation, like a classroom, where the biofeedback and performance of multiple users need to be assessed simultaneously, based on which changes may be brought about in the multimedia events. Thus they miss out on the vital aspect of group dynamics. Learning is much faster, easier and more enjoyable in a group, because there is high energy, people can learn by watching others, and people are less inhibited and willing to try new things.

Therefore, there exists a need in the art for a method and system for that may help man achieve his highest need of self-actualization, in a precise, scientific, repeatable manner, within even a classroom scenario that incorporates the benefits of group dynamics.

### SUMMARY OF INVENTION

Embodiments of the present invention relates to an interactive education system for stimulating higher cognitive processes of at least one user including an interactive interface for communicating with at least one user, a feedback component including an assessment module for assessing performance and/or understanding of the at least one user and a biofeedback module for detecting neurological, physiological, physical, genetic or any other type of biological and/or behavioral responses of the at least one user, either continuously or intermittently, a host processor including a multimedia module. The multimedia module includes at least one teaching module and a storage module, the storage module having at least one instruction stored therein for playing the at least one teaching module of the multimedia module, the storage module further performs at least one modification in the at least one teaching module of the multimedia module in response to data received from the assessment module and/or the biofeedback module and a communication network for coupling the feedback component to the host processor.

Embodiments of the present invention further relates to a method for stimulating higher cognitive processes of at least one user includes displaying at least one teaching module via an interactive interface of a multimedia module to the at least one user, obtaining assessment feedback of understanding and/or performance of the at least one user via an assessment module of a feedback component, obtaining biofeedback of the at least one user through neurological, physiological, physical and other similar parameters via a biofeedback module of the feedback component, compiling obtained assessment feedback of the at least one user and/or a multiple users, comparing an assessment profile of the at least one user and/or the multiple users to a pre-determined desired assessment profile, compiling obtained biofeedback into a physio-neurocognitive profile of the at least one user and/or the multiple users, comparing the physio-neurocognitive profile to a pre-determined desired physio-neurocognitive profile and determining any modification required in the at least one teaching module of the multimedia module in order to facilitate the at least one user and/or the multiple users to move towards the pre-determined desired physio-neurocognitive state.

The principal object of the present invention, is to introduce a system and method to help humanity evolve from its present lower cognitive state of fear, aggression, stress, competition and materialism, to its natural higher cognitive state of genius, creativity, focus, enthusiasm, intuition, vision, insight, altruism, awe, in a precise, scientific, objective, measurable and repeatable manner, implementable on a mass scale, across the world.

Another object of the present invention is to introduce a system and method of stimulating higher cognitive processes that is multimedia-based, yet interactive enough to be modified online, to help the user move to the desired physio-neurocognitive state of maximum creativity, focus, enthusiasm, intuition, vision and awe.

Another object of the present invention is to introduce a system and method of stimulating higher cognitive processes, which apart from individual training, may cater to an entire class or group at a time, and is thus able to incorporate the benefit of group dynamics in the learning process.

Another object of the present invention is to introduce a system and method of stimulating higher cognitive processes, based on one or more multimedia modules, assessment module and biofeedback module, which does not require the presence of skilled or expert teachers/supervisors, and thus be implemented on a mass scale around the world, helping humanity as a whole evolve to its true potential of creativity and genius.

While the invention is described herein by way of example using several embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modification, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Further, the words “a” or “an” mean “at least one” and the word “plurality” means one or more, unless otherwise mentioned.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits and advantages of the present invention will become apparent by reference to the following text figures, with like reference numbers referring to like structures across the views, wherein:

FIG. 1, illustrates a block diagram of an interactive education system for stimulating higher cognitive processes of one or more users, according to one embodiment of the present invention;

FIG. 2A, illustrates a perspective view of a classroom arrangement incorporating the interactive education system for stimulating higher cognitive processes of the one or more users, according to one embodiment of the present invention;

FIG. 2B, illustrates an exploded view of feedback component of the classroom arrangement for stimulating higher cognitive processes of the one or more users, according to one embodiment of the present invention; and

FIG. 3, illustrates a flow diagram of a method for stimulating higher cognitive processes of the one or more users, according to one embodiment of the present invention.

### DETAILED DESCRIPTION OF THE INVENTION

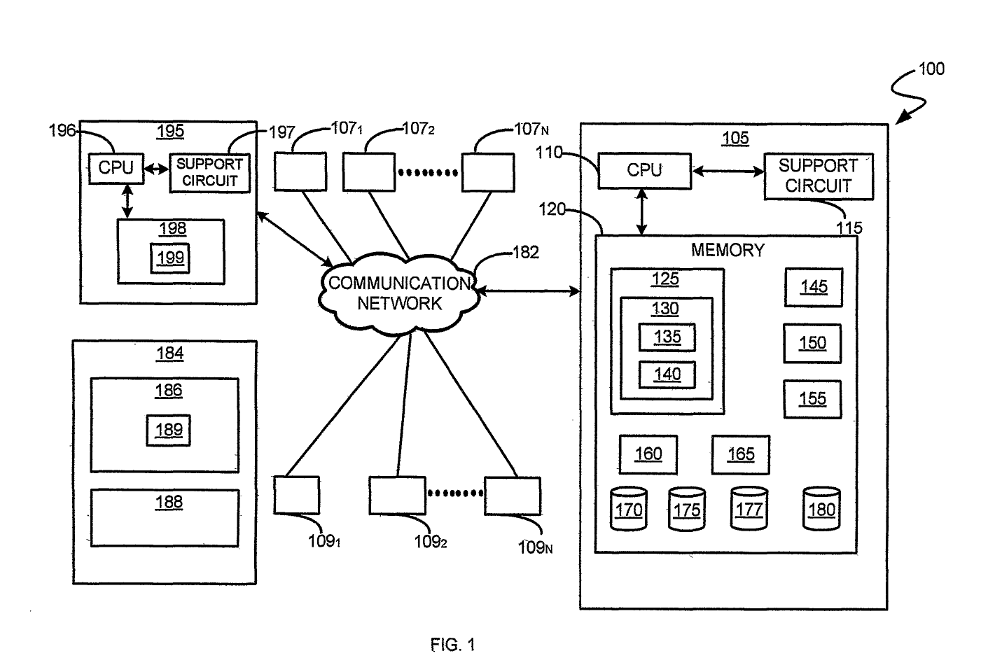

FIG. 1 illustrates a block diagram of an interactive education system 100 for stimulating higher cognitive processes of one or more users, according to one embodiment of the present invention. This figure only portrays one variation of the myriad of possible system configurations. The present invention may function in a variety of computing environments, such as, for example, but not limited to, a distributed computer system, a centralized computer system, a stand-alone computer system, or the like. One skilled in the art will appreciate that the system 100 may or may not contain all the components listed below.

The system 100 includes a host processor 105, a feedback component 184 at least one communication network 182, at least one server 195, a multiple output devices 107₁, 107₂ . . . 107ₙ and one or more user devices 109₁, 109₂ . . . 109ₙ. The at least one server 195 is coupled to the communication network 182. The host processor 105 is coupled to the communication network 182 to allow a personalization module 199 of the at least one server 195 to retrieve assessment data and/or biofeedback profile of the one or more users from the host processor 105 and to communicate a set of instructions by the personalization module 199 to modify at least one multimedia module 130 of the host processor 105 in order to precisely fine-tune the multimedia module 130 to be communicated to one or more users via the interactive interface to the user devices 109₁, 109₂ . . . 109ₙ to stimulate higher cognitive processes of the one or more users. Similarly, the user devices 109₁, 109₂ . . . 109ₙ are coupled to the communication network 182 in order to receive the at least one multimedia module 130 by the host processor 105. The communication link between the communication network 182 and the at least one server 195, the host processor 105, the multiple output devices 107₁, 107₂ . . . 107ₙ or the user devices 109₁, 109₂ . . . 109ₙ may be a physical link, a wireless link, a combination there of, or the like. The at least one server 195, multiple output devices 107₁, 107₂ . . . 107ₙ and the user devices 109₁, 109₂ . . . 109ₙ may be another computer system, a stand-alone device, a wireless device, or the like.

The host processor 105 may be coupled to the at least one server 195. In another embodiment, the host processor 105 may be coupled to the one or more servers 195 in one or more different locations. The host processor 105 may be remotely located from the at least one server 195. However, in other embodiments, a few or all of the functions performed by the host processor 105 as described below, may be included within and performed by the at least one server 195.

The host processor 105 is generally shown and described as processing the at least one teaching module 130, performing at least one modification in the at least one teaching module 130 of the multimedia module 125 in response to an input received from an assessment module 186 and/or a biofeedback module 188 of the feedback component 184 of the one or more users and distributing the teaching module 130 of the multimedia module 125 which may be modified to the one or more users to help them attain higher cognitive state via the interactive interface to the user devices 109. However, these three functions of the host processor 105 may be implemented on three distinct platforms, where one computer provides the processing function, a second computer provides the modification function and a third computer provides the distribution function. Those of ordinary skill in the art will appreciate that in various embodiments and throughout the disclosure, the term “host processor” is intended to encompass the distributed implementation as described herein as well as single entity host processor 105.

The host processor 105 may include at least one central processing unit (CPU) 110, support circuits 115, and memory 120. The CPU 110 may include one or more conventionally available microprocessors or microcontrollers. The microprocessor may be an application specific integrated circuit (ASIC). The support circuits 115 are well known circuits used to promote functionality of the CPU 110. Such circuits include, but are not limited to, a cache, power supplies, clock circuits, input/output (I/O) circuits and the like. The memory 120 contained within the host processor 105 may include random access memory, read only memory, removable disk memory, flash memory, and various combinations of these types of memory. The memory 120 may store the multimedia module 125 including the at least one teaching module 130, a wide spectrum sub-module 135, a recreational sub-module 140, a storage module 145, an assessment compilation module 150, a biofeedback compilation module 155, an assessment evaluation Module 160, a biofeedback evaluation module 165, an assessment parameter database 170, a biofeedback parameter database 175, a response database 177, a virtual agent database 180 and an operating system 152.

The operating system 152 may be one of a number of commercially available operating systems such as, but not limited to, SOLARIS from SUN Microsystems, Inc., AIX from IBM Inc., HP-UX from Hewlett Packard Corporation, LINUX from Red Hat Software, Windows 2000 from Microsoft Corporation, and the like.

The at least one server 195 may include a central processing unit (CPU) 196, support circuits 197, and memory 198. The CPU 196 may include one or more conventionally available microprocessors or microcontrollers. The CPU 196 may be an application specific integrated circuit (ASIC). The support circuits 197 are well known circuits used to promote functionality of the CPU 196. Such circuits include, but are not limited to, a cache, power supplies, clock circuits, input/output (I/O) circuits and the like. The memory 198 contained within the server 195 may include random access memory, read only memory, removable disk memory, flash memory, and various combinations of these types of memory. The memory 198 includes at least one personal interaction module 199 for facilitating participation of a teacher and/or a supervisor.

In one embodiment, the host processor 105 is configured to provide the at least one teaching module 130 of the multimedia module 125 to the one or more users via the interactive interface. The virtual agent is generated by the multimedia module 125 by retrieving at least one image from a multiple available images, and/or at least one animation from a multiple available animations, and/or at least one video from a multiple available videos, and/or at least one audio from a multiple available audios from the virtual agent database 180. The virtual agent interacts with the one or more users and communicates the at least one teaching module 130 of the multimedia module 125.

In one embodiment, the communication network 182 couples the feedback component 184 to the host processor 105.

In one embodiment, the at least one teaching module 130 includes the wide spectrum sub-module 135 and the recreational sub-module 140. The wide spectrum sub module 135 includes a wide spectrum of related topics for a specified subject matter, such as, for example, but not limited to, while learning a topic of “buoyancy” the wide spectrum sub module 135 may include one or more related subject matters such as body structure of fish (Biology), ship construction (Engineering), swimming (Sports), weightlessness in water and on moon (Physics) and the like. By the implementation of the wide spectrum sub module 135 the one or more users understand all the aspects of the subject matter and gain a holistic, practical and meaningful understanding of the topic. The recreational sub-module 140 includes one or more lighter topics, such as, for example, but not limited to, magic tricks, songs to sing, interesting facts, quizzes, games and the like that may or may not be related to the subject matter being studied. The instructions retrieved by the recreational sub-module 140, facilitate the one or more users in reducing stress and stimulate higher cognitive processes of enthusiasm, creativity, and humor in the one or more users.

In one embodiment, the feedback component 184 includes the assessment module 186 and the biofeedback module 188. The assessment module 186 assesses performance and/or understanding of the one or more users. The biofeedback module 188 detects neurological, physiological, physical, genetic or any other type of biological and/or behavioral responses of the one or more users.

In one embodiment, the assessment module 186 includes an objective sub-module 189. The objective sub-module 189 includes information details about one or more academic subjects for e.g. science, history, geography and the like. The information details may include correct answers of one or more questions of the one or more academic subjects.

In one embodiment, the objective sub-module 189 may be a simple hand-held component, a fixed component and the like where the one or more users have to press at least one button of a multiple buttons corresponding to one or more options available.

In one embodiment, the one or more buttons may correspond to option “YES” or “NO”.

In one embodiment, where the one or more users have to answer a multiple choice question, the one or more buttons may correspond to multiple options for e.g., “a” or “b” or “c” or “d”.

In one embodiment, the data recorded by the assessment module 186 of the one or more users is communicated to the storage module 145 of the host processor 105. The storage module 145 communicates the data received by the assessment module 186 to the assessment compilation module 150. The assessment compilation module 150 compiles the assessment data of one or more users. The compiled assessment data is communicated to the assessment evaluation module 160. The assessment evaluation module 160 compares the data received from the assessment compilation module 150 of each user of the one or more users with desired responses and/or performance retrieved from the assessment parameter database 170. Consequently, the assessment evaluation module 160 determines whether the one or more users are proficient in the one or more subjects being taught by the at least one teaching module 130.

In one embodiment, the assessment module 186 of the feedback component 184 includes at least one sensor-based unit, at least one keyboard, at least one mouse, at least one joystick, at least one touch screen, at least one microphone, at least one graphic tablet, and the like, or a combination thereof.

In one embodiment, the biofeedback module 188 detects biological and behavioral data, such as, for example, but not limited to, fear or hatred, boredom, tiredness, illness, and so on for the one or more subjects being taught to the one or more users. However, fear, hatred and physical illness are traits of the lower cognitive processes. Consequently, until these traits are overcome by the one or more users they will not be able to function at their highest capacity of genius, creativity, focus, enthusiasm, intuition, insight, vision, altruism and awe. The biofeedback module 188 includes one or more transducers of different kinds. The biofeedback module 188 monitors one or more parameters, such as, for example, but not limited to, neurological, physiological, physical, postural, behavioral, genetic and the like. The one or more parameters of the one or more users obtained by the biofeedback module 188 provide a comprehensive idea about the physio-neurocognitive state of each user.

In one embodiment, the biofeedback module 188 may include one or more motion sensors and/or one or more pressure sensors embedded within the chairs and/or floor for detecting restlessness, movement, distraction, focus, posture and concentration of the one or more users.

In another embodiment, the biofeedback module 188 may include one or more temperature sensors in necklaces, wristbands and the like. The one or more temperature sensors determine the sympathetic and/or the parasympathetic activity, thyroid activity and the like of the one or more users.

In another embodiment, the biofeedback modules 188 may include a camera to see eye direction of the one or more users to check focus, areas of interest, eye luster of the one or more users to determine enthusiasm and involvement in learning the teaching module 130.

In another embodiment, the biofeedback modules 188 may include one or more heart rate sensors to determine excitement, fear, anger and stress of the one or more users.

In another embodiment, the biofeedback modules 188 may include one or more blood oxygenation infrared sensors to determine calmness and/or relaxed physiological state of the one or more users.

In one embodiment, the components of biofeedback module 188 are out of sight and are embedded within the one or more output devices 107 and/or camouflaged as integral components of caps, bands, rings and the like. Subsequently, the biofeedback module 188 obtains natural reactions of the one or more users without distortion due to self-consciousness and/or nervousness.

In one embodiment, the biofeedback module 188 detects the biological and behavioral signals of the one or more users on a continuous basis, to obtain precise understanding about the impact of the teaching module 130 on the one or more users.

In another embodiment, the biofeedback module 188 detects the biological and behavioral signals of the one or more users intermittently, during specific parts of the teaching module 130 initiated by the storage module 145 based on predetermined instructions stored in the response database 177, and/or by the instructions communicated by the personalization module 199 of the server 195 to the multimedia modules 125 of the host processor 105. The teacher and/or supervisor perform one or more changes in the personalization module 199 based on the proceedings in a group, classroom and/or on an individual basis where the system 100 is being deployed to stimulate higher cognitive processes.

However, one or more types of the biofeedback module 188 may be deployed together and/or in combination in the one or more embodiments of the present invention. A person skilled in the art would appreciate that there may be numerous such biological and behavioral parameters and one or more transducers which may be utilized to detect the biological and behavioral aspects of the one or more users.

In another embodiment, the assessment compilation module 150 of the host processor 105 compiles the data of multiple users together to evaluate an overall performance of a group of the multiple users.

In one embodiment, the storage module 145 includes one or more instructions for playing the at least one teaching module 130 of the multimedia module 125.

In one embodiment, one or more physio-neurocognitive changes that the one or more users undergo during learning process of the teaching module 130 are continuously or intermittently detected by the biofeedback module 188 of the feedback component 184.

In one embodiment, the assessment compilation module 150 compiles obtained assessment feedback of the one or more users and/or the multiple users. The biofeedback compilation module 155 compiles obtained biofeedback into the physio-neurocognitive profile of each user of the one or more users.

In another embodiment of the present invention, the biofeedback compilation module 155 compiles obtained biofeedback into the overall physio-neurocognitive profile of the one or more users and/or the multiple users.

In one embodiment, the assessment evaluation module 160 compares an assessment profile of the one or more users and/or the multiple users to a pre-determined desired assessment profile stored in the assessment parameter database 170. The biofeedback evaluation module 165 compares the physio-neurocognitive profile to a pre-determined desired physio-neurocognitive profile that should be present at that time, depending on the subject matter being taught stored in the biofeedback parameter database 175. The storage module 145 performs one or more modifications in the at least one teaching module 130 of the multimedia module 125 in response to data received from the assessment module 186 and/or the biofeedback module 188.

In one embodiment, the biofeedback module 188 detects the biological and behavioral signals of the one or more users on a continuous basis, to obtain precise understanding about the impact of the teaching module 130 on the one or more users.

In another embodiment, the biofeedback module 188 detects the biological and behavioral signals of the one or more users intermittently, during specific parts of the teaching module 130 initiated by the storage module 145 based on predetermined instructions, and/or by the instructions communicated by the personalization module 199 of the server 195 to the storage module 145 of the host processor 105. The supervisor performs one or more changes in the personalization module 199 of the server 195 based on the proceedings in a group, classroom and/or on an individual basis where the system 100 is being deployed to stimulate higher cognitive processes.

In one embodiment, the system 100 further includes the one or more output devices 107 for further stimulating a physio-neurocognitive state of the one or more users and/or the multiple users. The one or more output devices 107 may include various kinds of lighting, fog, fragrances, tactile and other special effects, means to physically move the chairs of the users in any manner, or any other form of output means, that may be ambient for all users, or could be individually fitted for each user, or a combination of both.

In one embodiment, if the biofeedback data received from the biofeedback module 188 demonstrates that most of the users are very stressed for e.g., reflected through the GSR, Heart rate, EEG consequently, the multimedia module 125 have a set of instruction to activate the recreational sub-module 140. The recreational sub-module 140 plays a song, trick or game, to give the one or more users a break from the teaching module 130. Subsequently, the recreational sub-module 140 helps the one or more users to become more happy, relaxed and enthusiastic.

In another embodiment of the present invention, if the biofeedback data received from the biofeedback module 188 demonstrates that most of the users are happy and enthusiastic. Consequently, the multimedia module 125 includes a set of instructions to activate a challenging topic of the teaching module 130. Subsequently, the multimedia module 125 takes advantage of the higher cognitive functioning of the one or more users.

In another embodiment of the present invention, however if the biofeedback evaluation module 165 determine that most of the users are happy and enthusiastic but the assessment evaluation module 160 determines that the one or more users are making a particular mistake the multimedia module 125 repeats the same subject matter in the teaching module 130 at a lower speed, to ensure that the one or more users are able to correct their mistake.

In another embodiment of the present invention, storage module 145 performs one or more modifications in the at least one teaching module 130 of the multimedia module 125 based on one or more predetermined instructions stored in the response database 177, to help the one or users to move from present physio-neurocognitive state to the preferred ideal physio-neurocognitive state.

In one embodiment, the interactive interface presents the multimedia modules 125 in a textual, audio, visual, or audiovisual format via the user devices 109 to the one or more users.

In one embodiment, the user devices 109 may be an individual display screen, common display screen a personal computer.

In one embodiment, the host processor 105 performs any other operation as required by various embodiments of the present invention.

In one embodiment, each user has an individual display screen. The one or more modifications in the multimedia module 125 may be based on the user physio-neurocognitive profile and the assessment data.

In another embodiment, if there is a common display screen for the one or more users, the one or more modifications in the multimedia module 125 is based on the overall physio-neurocognitive profiles and the assessment data of all the users.

In another embodiment, personalized questions may be given to each user, based on his/her individual physio-cognitive profile and the assessment data. Subsequently, the learning process is fine-tuned to ensure that each user gains maximum benefit.

In one embodiment, the interactive interface communicates an output to the one or more users based on a selection of at least one output response of a multiple possible output responses stored in the response database 177.

In one embodiment, the response database 177 stores one or more predetermined instructions regarding initiation and/or one or more modifications in the multimedia module 125. Moreover, the response database 177 stores one or more predetermined instructions regarding one or more modifications based on the data received from the assessment module 186 and/or the biofeedback module 188 of the feedback component 184.

In one embodiment, the assessment module 186 of the feedback component 184 includes at least one sensor-based unit, at least one keyboard, at least one mouse, at least one joystick, at least one touch screen, at least one microphone, at least one graphic tablet, and the like, or a combination thereof.

In one embodiment, the personalization module 199 modifies the teaching module 130 based on the physio-neurocognitive profile and the assessment data of the users. The virtual agent is retrieved from the virtual database 180 which addresses the one or more users by name when a set of instructions are received from the personalization module 199.

However, the personalization module 199 helps the one or more users to connect to the supervisor of the server 195 and helps the one or more users to move to the higher cognitive state.

The storage module 145 stores a multiple audio clips of names of the one or more users, stores videos clips of numerous personal statements to be played to the one or more users based on pre-determined parameters stored in the response database 177.

In one embodiment, the multimedia module 125 displays the selected video clip from the multiple video clips through the interactive interface. However, the part of the audio-visual clip the virtual agent has to speak a name of the user has no audio, and lip movements are deliberately vague. In another embodiment, each such statement may be spoken multiple times, moving the lips briefly to allow for shorter' names, and for longer time to allow for longer names.

In another embodiment, based on the biofeedback profile, the assessment data and/or any other information such as birthdates and personal details of each user, the host processor 105 selects a user to address, and a suitable statement retrieved from the storage module 145 to make to the user. The multimedia module 125 displays the audio-visual clip, and at the time when the virtual agent begins to move his/her lips to state the name of the user, the multimedia module 125 plays the audio clip stating the name, subsequently performing the entire operation seamlessly.

In another embodiment, instead of one or more audio clips stating the entire name of each user, the audio clips could merely state the various possible phonemes and/or syllables particular to that language, such that when the multimedia module 125 selects the user to be addressed, it also compiles together the audio clips of the particular phonemes and/or syllables, and plays them in sequence, to form the name of the user selected. The advantage of this embodiment is that there is no need to separately record the names of users of each new batch or course. Any name may be compiled online, as necessary.

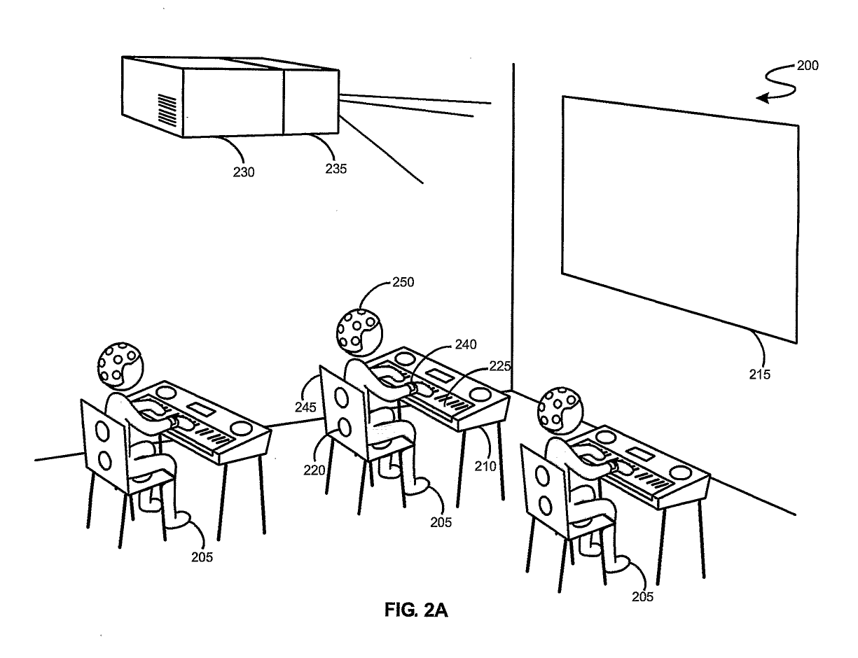

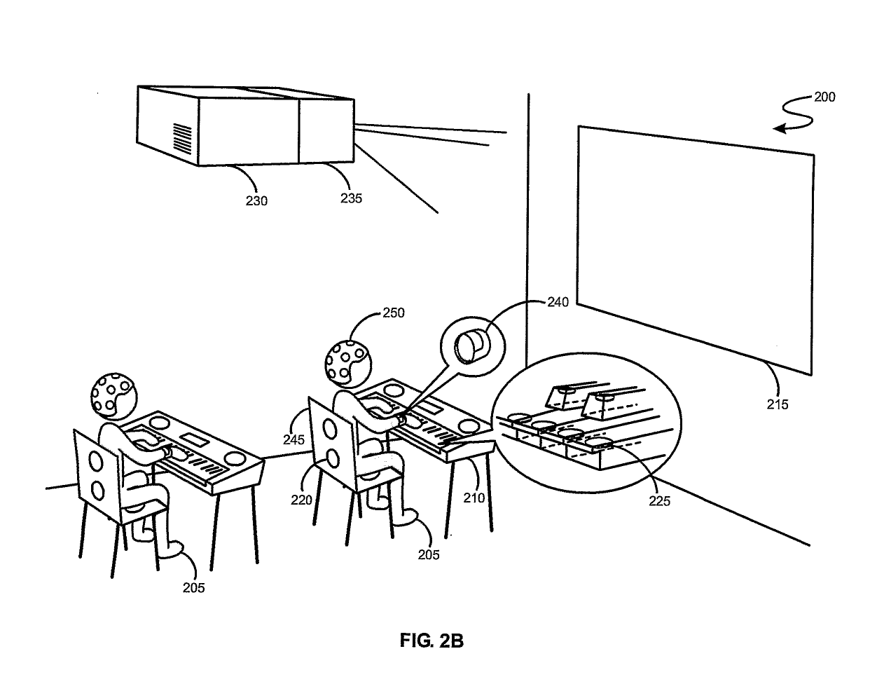

FIG. 2A illustrates a perspective view of a classroom arrangement 200 incorporating the system 100 (of FIG. 1) for stimulating higher cognitive processes of the one or more users 205, and FIG. 2B, illustrates an exploded view of feedback component of the classroom arrangement 200 for stimulating higher cognitive processes of the one or more users, according to one embodiment of the present invention.

In one embodiment, the classroom arrangement 200 includes the one or more users 205 playing user devices 210. The one or more teaching modules 130 (of FIG. 1) of the multimedia module 125 (of FIG. 1) are displayed through a projector 235 on a display screen 215. The one or more sensors 225 of the assessment module 186 (of FIG. 1) of the feedback component 184 (of FIG. 1) have been deployed for a keyboard-based music education. The one or more sensors 225 are placed below each key of the user devices 210. Moreover, the one or more sensors 225 come in contact with the one or more keys of the user device 210, when the one or more keys of the user device 210 are depressed by the one or more users 205. The data recorded by the one or more sensors 225 are communicated to the assessment compilation module 150 (of FIG. 1) via the storage module 145 (of FIG. 1). The assessment evaluation module 160 (of FIG. 1) compares the data with one or more parameters stored in the assessment parameter database 170 (of FIG. 1).

In one embodiment, the data sensed by the one or more sensors 225 of the assessment module 186 may include information about which key has been played and pressed (pitch), time duration of the press, pressure applied on the one or more keys of the user device 210 by the one or more users 205 that may be loud or soft, the position and movement of the fingers of the one or more users 205 on the one or more keys of the user device 210 and the like.

In one embodiment, the assessment module 186 may detect an exact pitch, timing and one or more parameters which is communicated to the assessment evaluation module 160 via the storage module 145 of the host processor 230. The assessment evaluation module 160 evaluates musical performance of the one or more users with an accuracy that would be impossible for a human ear to detect.

Moreover, the one or more sensors 225 of the assessment module 186 are just one kind of the assessment module 186 of the feedback component 184 which has been employed for the classroom arrangement 200. It should be understood that the type of the assessment module 186 will vary according to the subject being taught and assessed by the system 100.

In one embodiment, the assessment module 186 is out of sight of the one or more users 205. Further, the assessment module 186 is embedded within the user device 210. Consequently, this aids in preventing self-consciousness, nervousness and inhibitions of the one or more users 205 playing the user device 210 and provides with a far more accurate assessment of the skill and understanding of the one or more users 205.

In one embodiment, the one or more teaching modules 130 of the multimedia module 125 stimulate the higher cognitive processes in the one or more users 205. The higher cognitive processes may include curiosity, enthusiasm, intuition and love for learning.

In one embodiment, the user device 210 May be a keyboard based instrument and the like. In one embodiment, the one or more teaching modules 130 of the multimedia module 125 may be displayed on a television screen, a computer monitor and the like.

In another embodiment of the present invention, the display screen 215 may be provided to the one or more users 205 individually.

In one embodiment, the biofeedback modules 188 (of FIG. 1) deployed in the classroom arrangement 200 may include head caps with EEG sensors 250, wristbands with Galvanic Skin Response (GSR) sensors 240 and one or more pressure sensors 220 embedded within a chair 245.

In one embodiment, the Galvanic Skin Response (GSR) sensors 240 in wristbands, rings, or any other commodity detects sweat changes of the one or more users 205. The sweat changes detected by the GSR sensors 240 of the one or more users 205 determine a sympathetic activity of the one or more users 205. The sympathetic activity includes stressed state and alert state of the one or more users 205. The biofeedback parameter database 175 of the host processor 230 includes one or more parameters of the stressed state, the alert state, calm state and relaxed state. The calm state and relaxed state relates to parasympathetic activity.

In one embodiment, a head cap with EEG sensors 250 measures brainwave of the one or more users 205. Moreover, the head cap with EEG sensors 250 detects an area of the brain which is more active, and determines quality of brainwaves. The quality of brainwaves refers to calmness and/or meditative (alpha waves), alertness (beta waves) and the like of the one or more users 205.

In one embodiment, one or more pressure sensors 220 are embedded within one or more chairs 245. The one or more pressure sensors 220 detects posture changes of the one or more users 205 which determines mental attitude of the one or more users 205 toward the teaching module 130 being taught.

In one embodiment, the host processor 230 is similar in operation to the host processor 105 (of FIG. 1).

However, the classroom arrangement 200 is just one category of a multiple categories which may deploy the system 100 to stimulate higher cognitive processes of the one or more users 205.

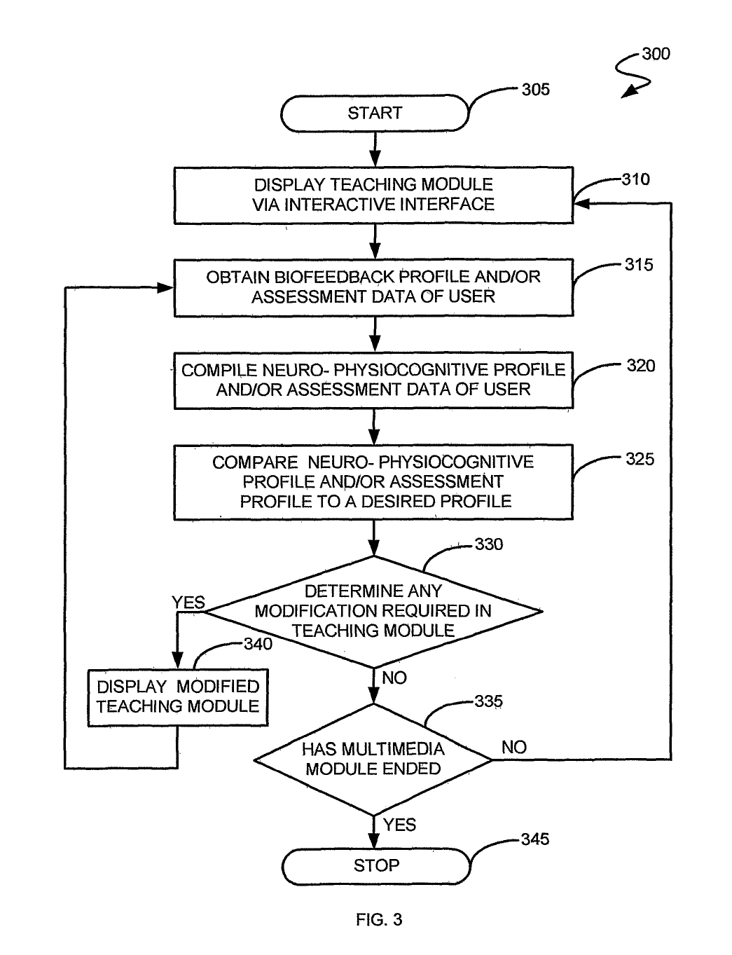

FIG. 3, it illustrates a flowchart of a method 300 for stimulating higher cognitive processes of the one or more users, according to one embodiment of the present invention. The method 300 begins at step 305 and proceeds to step 310. At step 310, the method 300 includes displaying the teaching module 130 (of FIG. 1) of the multimedia module 125 (of FIG. 1) via the interactive interface on the display screen and the like to the one or more users. Moreover, the virtual agent is generated by the multimedia module 125 by retrieving the at least one image from the multiple available images, and/or the at least one animation from the multiple available animations, and/or the at least one video from the multiple available videos, and/or the at least one audio from the multiple available audios from the virtual agent database 180 (of FIG. 1). The virtual agent interacts with the one or more users and communicates the at least one teaching module 130 of the multimedia module 125. At step 315, the biofeedback profile and the assessment data of the one or more users is obtained by the biofeedback module 188 (of FIG. 1) and the assessment module 186 (of FIG. 1) of the feedback component 184 (of FIG. 1). Moreover, the obtained biofeedback profile and the assessment data of the one or more users are communicated to the storage module 145 (of FIG. 1) of the host processor 105 (of FIG. 1) by the biofeedback module 188 and the assessment module 186 respectively. At step 320, the assessment compilation module 150 (of FIG. 1) compiles the assessment data of the one or more users and the biofeedback compilation module 155 (of FIG. 1) compiles the biofeedback profile of the one or more users.

In another embodiment of the present invention, the assessment compilation module 150 compiles the overall assessment data of the one or more users and the biofeedback compilation module 155 compiles the overall biofeedback profile of the one or more users.

At step 325, the assessment evaluation module 160 (of FIG. 1) compares the data received from the assessment compilation module 150 of each user of the one or more users with the desired responses and/or performance retrieved from the assessment parameter database 170 (of FIG. 1) and the biofeedback evaluation module 165 (of FIG. 1) compares the data received from the biofeedback compilation module 155 of each user of the one or more users with the desired responses and/or performance retrieved from the biofeedback parameter database 175 (of FIG. 1). At step 330, a determination is Made as to whether any modification is required in the teaching module 130 of the multimedia module 125. If the modification is required in the teaching module 130 of the multimedia module 125 option “YES”, the method 300 proceeds to step 340. At step 340, the storage module 145 performs one or more modifications in the at least one teaching module 130 of the multimedia module 125 based the on one or more predetermined instructions stored in the response database 177, for helping the one or users for moving from present physio-neurocognitive state to the preferred ideal physio-neurocognitive state.

In another embodiment of the present invention, the personalization module 199 (of FIG. 1) of the server 195 (of FIG. 1) communicates via the communication network 182 (of FIG. 1) a set of instructions to modify the teaching module 130 of the host processor 105 based on the biofeedback profile and the assessment data of the one or more users. The method 300 proceeds to step 315.

In one embodiment, if the modification is not required in the teaching module 130 of the multimedia module 125 option “NO”, the method 300 proceeds to step 335. At step 335, a determination is made as to whether the multimedia module 125 has ended. If the multimedia module 125 has not ended option “NO”, the method 300 proceeds to step 310. In one embodiment, if the multimedia module 125 has ended option “YES”, the method 300 proceeds to step 345. At step 345, the method 300 ends.

Therefore, as can be seen, embodiments of the present invention provide a system and method which has been designed to stimulate higher cognitive processes of creativity, genius, focus, enthusiasm, intuition, vision, insight, altruism, awe and so on, in any person of any age, in a precise, scientific, objective, measurable and repeatable manner. Consequently, it makes the present invention to be implemented on a global scale, across the world. The present invention helps humanity as a whole to evolve to its true potential. Moreover, the present invention provides instant, online, real time assessment, for each user. Subsequently, the present invention corrects mistake of the user immediately, which is not possible for a live teacher. Moreover, the present invention eliminates the need for highly trained teachers to be present in the classroom, since the assessment modules provides far more accurate and faster results even than an expert. Furthermore, the present invention is based on the utilization of the one or more multimedia modules which enable the creative genius of self-actualized experts to be distributed across the world for generations to come. The one or more users learn through these multimedia modules naturally imbibe their higher cognitive state, and undergo profound improvements at all levels—cognitive, neurological, physiological, endocrinal, right down to fundamental genetic and molecular changes.

Furthermore, based on the feedback component, and the personalization module in the system, the present invention brings about continuous, online changes in the one or more multimedia modules and precisely fine-tune the multimedia modules to stimulate higher cognitive processes in the users—making the present invention a continuously evolving, dynamic and organic system, designed to free each user from their present genetic and societal limitations, into the abundant super-humans they really are. Most importantly, the present invention enables the dissemination of the biofeedback data, assessment data and the teacher/supervisor's observations to teachers and researchers across the world enabling them to identify, understand and solve learning patterns and problems among different cultures and age groups. Its implications in the fields of anthropology, genetics and healthcare are staggering as this data would lend invaluable insight into the causes of genetic and cultural problems. The present invention is the biggest research tool that compiles data from across the world, to bring about simultaneous changes in cultures across the world, in the most vital field of human-ware.

In the foregoing specification, specific embodiments of the present invention have been described. However, one of ordinary skill in the art will appreciate that various modifications and changes can be made without departing from the spirit and scope of the present invention as set forth in the various embodiments discussed above and the claims that follow. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements as described herein.

We claim:

1. An interactive education system for stimulating higher cognitive processes of at least one user, said system comprising:
an interactive interface for communicating with at least one user;
a feedback component comprising:
an assessment module for assessing performance and/or understanding of said at least one user; and
a biofeedback module for detecting neurological, physiological, physical, genetic or any other type of biological and/or behavioral responses of said at least one user, either continuously or intermittently;
a host processor comprising a multimedia module, said multimedia module comprises at least one teaching Module and a storage module, said storage module having at least one instruction stored therein for playing said at least one teaching module of said multimedia module, said storage module further performs at least one modification in said at least one teaching module of said multimedia module in response to data received from said assessment module and/or said biofeedback module; and
a communication network for coupling said feedback component to said host processor.

2. The system of claim 1, wherein said system further comprises a server comprising at least one personal interaction module for facilitating participation of a teacher and/or a supervisor.

3. The system of claim 1, wherein said system further comprises a virtual agent generated by retrieving at least one image from a plurality of available images, and/or at least one animation from a plurality of available animations, and/or at least one video from a plurality of available videos, and/or at least one audio from a plurality of available audios from a virtual agent database, said virtual agent interacts with said at least one user.

4. The system of claim 1, wherein said system further comprises at least one output device for further stimulating a physio-neurocognitive state of said at least one user and/or said plurality of users.

5. The system of claim 3, wherein said system further comprises an assessment compilation module compiling obtained assessment feedback of said at least one user and/or a plurality of users and a biofeedback compilation module compiling obtained biofeedback into a physio-neurocognitive profile of said at least one user and/or said plurality of users.

6. The system of claim 5, wherein said system further comprises an assessment evaluation module comparing an assessment profile of said at least on user and/or said plurality of users to a pre-determined desired assessment profile stored in an assessment parameter database and a biofeedback evaluation module comparing said physio-neurocognitive profile to a pre-determined desired physio-neurocognitive profile stored in an biofeedback parameter database.

7. The system of claim 1, wherein said at least one teaching module comprises a wide spectrum sub-module and a recreational sub-module.

8. The system of claim 1, wherein said assessment module comprises an objective sub-module.

9. The system of claim 1, wherein said interactive interface is configured to communicate an output to said at least one user based on a selection of at least one output response of a plurality of possible output responses stored in a response database.

10. The system of claim 1, wherein said assessment module of said feedback component comprises at least one sensor-based unit, at least one keyboard, at least one mouse, at least one joystick, at least one touch screen, at least one microphone, at least one graphic tablet, and the like, or a combination thereof.

11. The system of claim 1, wherein said biofeedback module of said feedback component comprises at least one transducer for detecting neurological, physiological, physical, genetic, or any other type of biological and/or behavioral parameters.

12. A method for stimulating higher cognitive processes of at least one user, said method comprising:
(a) displaying at least one teaching module via an interactive interface of a multimedia module to said at least one user;
(b) obtaining assessment feedback of understanding and/or performance of said at least one user via an assessment module of a feedback component;
(c) obtaining biofeedback of said at least one user through neurological, physiological, physical and other similar parameters via a biofeedback module of said feedback component;
(d) compiling obtained assessment feedback of said at least one user and/or a plurality of users;
(e) comparing an assessment profile of said at least one user and/or said plurality of users to a pre-determined desired assessment profile;
(f) compiling obtained biofeedback into a physio-neurocognitive profile of said at least one user and/or said plurality of users;
(g) comparing said physio-neurocognitive profile to a pre-determined desired physio-neurocognitive profile; and
(h) determining any modification required in, said at least one teaching module of said multimedia module in order to facilitate said at least one user and/or said plurality of users to move towards said pre-determined desired physio-neurocognitive state.

13. The method of claim 12, wherein an assessment compilation module compiles obtained assessment feedback of said at least one user and/or said plurality of users and a biofeedback compilation module compiles obtained biofeedback into said physio-neurocognitive profile of said at least one user and/or said plurality of users.

14. The method of claim 12, wherein an assessment evaluation module compares said assessment profile of said at least one user and/or said plurality of users to said pre-determined desired assessment profile stored in an assessment parameter database and a biofeedback evaluation module compares said physio-neurocognitive profile to said pre-determined desired physio-neurocognitive profile stored in an biofeedback parameter database.

15. The method of claim 12, wherein said method further comprises activating a plurality of output devices to further stimulate the physio-neurocognitive state of said at least one user and/or said plurality of users.

16. The method of claim 12, wherein said method further comprises accepting a set of instructions from a teacher and/or a supervisor via a personalization module to bring about modification in said at least one teaching module of said multimedia module.

17. The method of claim 12, wherein a virtual agent is generated by retrieving at least one image from a plurality of available images, and/or at least one animation from a plurality of available animations, and/or at least one video from a plurality of available videos, and/or at least one audio from a plurality of available audios from a virtual agent database, said virtual agent interacts with said at least one user.
